(19) United States
(12) Patent Application Publication
(10) Pub. No.: US 2023/0110892 A1
(43) Pub. Date: Apr. 13, 2023

(54) AGENDA WITH INTEGRATED HOUSING FOR WRITING INSTRUMENT AND METHOD FOR ITS MANUFACTURING

(71) Applicant: FIORDO SRL, Romentino (NO) (IT)

(72) Inventor: Fiorenzo DONATI, Romentino (NO) (IT)

(73) Assignee: FIORDO SRL, Romentino (NO) (IT)

(21) Appl. No.: 17/931,196

(22) Filed: Sep. 12, 2022

(30) Foreign Application Priority Data
Sep. 13, 2021 (EP) 21196426.7

(51) Int. Cl. B42D 5/00

(52) U.S. Cl. CPC B42D 5/006; B42D 5/008; B42P 2241/18

(57) ABSTRACT

A method for making an agenda with an integrated housing for a writing instrument is disclosed. The method uses a sheet having lines of creases and a plurality of elements which form the cover of the agenda and are mutually separated in their inside by corresponding first parallel creases, and a plurality of quadrangular strips separated in their inside by second creases arranged transversely to the first parallel creases. The plurality of strips is connected to a first element of the plurality of elements. The plurality of strips is folded to form a tubular frame. One of the strips adheres to the surface of the first element to fasten the tubular frame. The plurality of elements is folded so that the first element is a part of one side of the agenda cover, and a second element is a part of a second side of the agenda cover. A block of sheets is fastened to the sheet and extends below the tubular frame.

### CROSS-REFERENCE TO RELATED APPLICATIONS

This application claims the benefit of priority from European Patent application No. EP 21196426.7 filed on Sep. 13, 2021, the contents of which are incorporated herein by reference.

### FIELD OF THE INVENTION

An object of the present invention is to provide a method and a die-cut sheet for making an agenda equipped with an integrated housing for a writing instrument.

In particular, an object of the present invention is a method and a die-cut paper material sheet for making an agenda configured in such a way as to be able to also accommodate a writing instrument, such as a pen, a pencil, a marker, a ruler, a rubber, etc. or a combination thereof.

### BACKGROUND OF THE INVENTION

Notebooks are known which are simply formed by a block of detachable paper sheets which is applied on a cardboard support laterally supporting a surface intended to accommodate a pen.

The document EP 3323625 A1 describes a notebook made by means of a paper-making method, in which from a single die-cut sheet, preferably made of card stock, a support is made for the block of sheets of the notebook equipped at the top with a prismatic compartment for a pen.

In EP 3323625 A1, the end flap of this compartment also acts as a fin for protecting the binding of the block of sheets of the same notebook.

The shape of the compartment for a pen of EP 3323625 A1 de facto prevents the notebook from being able to be flipped through like a book and therefore that instead of the notebook, an agenda, i.e., a block of sheets bound like a book is used.

The Chinese utility model CN 2080462 U describes an agenda with a support obtained from a cardboard sheet or plate and a pen-holder case, also made of cardboard, which is integrated on such a support. The case is made separately from the support and is therefore fastened subsequently to the aforesaid support.

### SUMMARY AND OBJECTS OF THE INVENTION

An object of the present invention is to implement an agenda with an integrated housing for a writing instrument, by making use, at least partially, of a paper-making method in a simple and economical way.

Another object of the invention is to implement an agenda with an integrated housing for a writing instrument which, by using only paper material for the cover and the respective block of sheets, complies with the objectives of reducing pollution from plastic or synthetic materials.

It is still another object of the present invention to implement an agenda, with a book-like opening, equipped with a respective paper material support, i.e., cover, with an integrated housing for a writing instrument, such as e.g. a pen or a pencil or a ruler, etc., wherein said support can be easily obtained from a single paper material plate or sheet through a paper-making method.

These objects are achieved by a method for making an agenda with an integrated housing for at least one writing instrument, the aforesaid agenda being achievable by folding a die-cut paper material sheet provided with lines of pre-set folding or creases, where the aforesaid sheet has at least one plurality of elements adapted to form the cover of the aforesaid agenda and mutually separated in their inside by corresponding first parallel creases, and at least one plurality of preferably quadrangular strips mutually separated in their inside by corresponding second creases which are arranged transversely to said first parallel creases, said plurality of preferably quadrangular strips being connected, through its own crease, to a first element of the aforesaid plurality of elements, the method comprising at least the following steps:
folding the plurality of preferably quadrangular strips, in such a way as to form a tubular frame in which one of the aforesaid strips is adhered to the surface of the aforesaid first element to fasten the tubular frame in position;
folding said plurality of elements so that said first element constitutes at least part of one side of the agenda cover, a second element constituting at least part of a second side of the agenda cover;
fastening at least one block of sheets to the die-cut sheet, preferably at the aforesaid first element and/or the aforesaid second element, so that the block of sheets extends below said tubular frame.

In the present description, the expression “paper-making method” means a method in which a flat plate or sheet of card stock or cardboard, or other paper material, is treated with creasing, die cutting and folding in order to obtain an object of common use.

The term “block of sheets” means a block of sheets bound on one side, e.g., by gluing, sealing, or plastic comb binding, or other. A book-like bound block of sheets will be equipped with a binding that allows the user to flip through such block as if it were a common book.

Preferably, said quadrangular elements are at least three and said quadrangular strips are at least four.

It should be noted that the expression “tubular frame” herein means a generally cylindrical or prismatic or, in any case, polyhedral frame, even if not extending rectilinearly, which is closed on the sides and has at least one open base and which is capable of housing, without the aid of other components other than its side surfaces made through the aforesaid strips, e.g. at least one writing instrument, such as a pen, a pencil, a ruler, a rubber to erase, etc.

The ease of making and effectiveness of use that this agenda shows, is essentially due to the particular implementation of the aforesaid tubular frame.

It should also be noted that the aforementioned feature described and claimed herein as “the block of sheets extends below said tubular frame” means that the tubular frame is arranged above the block of paper sheets so that it does not hinder the flipping through of the paper sheets of the block. In other words, the tubular frame never overlaps the block of paper sheets, so that full accessibility to the agenda is allowed.

According to a preferred aspect of the invention, the tubular frame is also arranged transversely to the direction of binding of the pages of the block of paper sheets to allow the user to flip through the sheets of the block of paper sheets, i.e. through the agenda, and to be able to write in it without being prevented by the encumbrance of the tubular frame.

According to a further preferred aspect of the invention, the method may preferably comprise, but not necessarily, after the aforesaid step of folding the plurality of quadrangular strips, one or both of the steps of:
positioning and fastening at least one third element above said first element, in such a way that the aforesaid third element surmounts or flanks the aforesaid strip which adheres to the first element, to form at least one first side of the agenda cover; and/or
positioning and fastening at least one fourth element above the second element in such a way as to form at least part of a second side of the agenda cover.

According to another aspect of the invention, at least one element of the plurality of elements comprises one or more perimeter flaps which are preferably quadrangular and even more preferably shaped as an isosceles trapezium, separated from the respective element thanks to third creases which are also transverse to said first creases, the method also comprising the step of folding and fastening said perimeter flaps to define at least said first and said second sides of the agenda cover.

These steps allow to strengthen at least part of the sides of the agenda cover.

Among the advantages of this implementation is that an agenda, which is equipped with an integrated housing for a writing instrument, can be formed from a single sheet of cardboard or card stock, or other paper material, by means of a few simple steps.

In a preferred embodiment of the invention, the die-cut sheet comprises one or more additional fins which, in an embodiment of the method of this invention, are subjected to a further folding step to close a side (base) of the tubular frame.

Other characteristics of the invention can be deduced from the claims.

### BRIEF DESCRIPTION OF THE FIGURES

Further characteristics and advantages of the invention will become clear from reading the following description provided by way of non-limiting example, with the aid of the figures depicted in the accompanying drawings, wherein:

FIG. 1 is a plan view of a cardboard or card stock sheet, according to an implementation of the invention;

FIG. 2 is a plan view of the sheet of FIG. 1 in a first step of making the agenda of the invention;

FIG. 3 is a plan and side view of the sheet of FIG. 1 in a second step of making the agenda of the invention;

FIG. 4 is a plan view of a cardboard or card stock sheet, according to a second implementation of the invention;

FIG. 5 is a plan view of the sheet of FIG. 4 in a first step of making the agenda of the invention;

FIG. 6 is a plan and side view of the sheet of FIG. 4 in a second step of making the agenda of the invention;

FIG. 7 is an axonometric view of the agenda of the invention, in a making step;

FIG. 8 is a further axonometric view of the agenda of FIG. 3 of the invention in open configuration;

FIG. 9 is a further axonometric view of the agenda of FIG. 1 of the invention in open configuration;

FIG. 10 is an axonometric view of the agenda of the invention in closed configuration;

FIG. 11 is a plan view of a cardboard or card stock sheet, according to a further third embodiment of the invention;

FIG. 12 is a plan and side view of the sheet of FIG. 11 in a first step of making the agenda of the invention;

FIG. 13 is a plan and side view of the sheet of FIG. 11 in a second step of making the agenda of the invention;

FIG. 14 is an axonometric view of the cover implemented with the sheet of FIG. 11, before a block of sheets is fastened thereto.

### DETAILED DESCRIPTION OF THE INVENTION

The present invention will now be described with particular reference to the accompanying figures in which, in addition to the die-cut paper material sheet intended to constitute the cover (or support) of the agenda with integrated housing for a writing instrument, according to an implementation of the invention, some steps of folding such die-cut sheet and the agenda obtained at the end of this method, can also be seen.

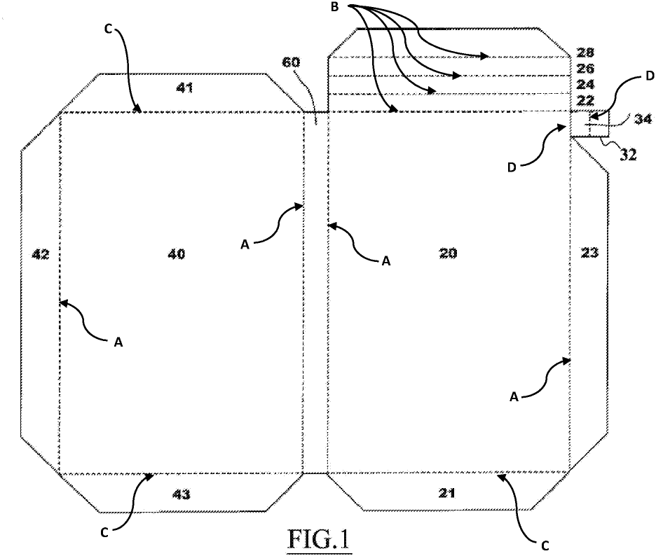

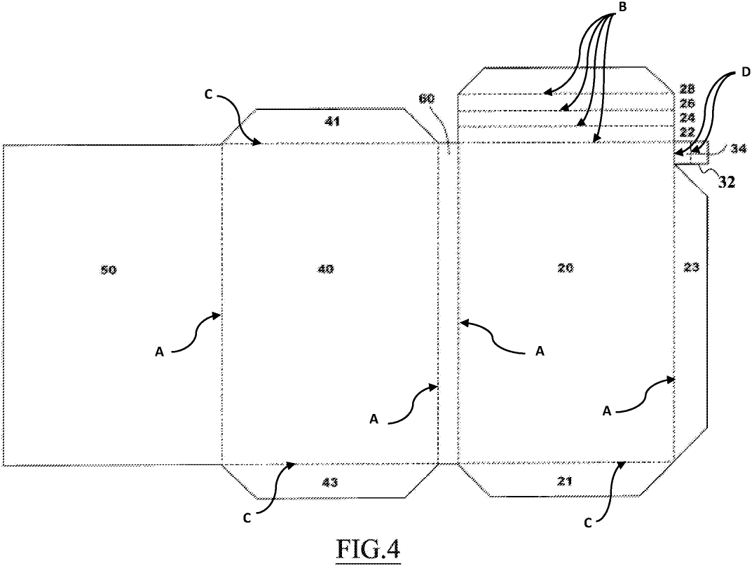

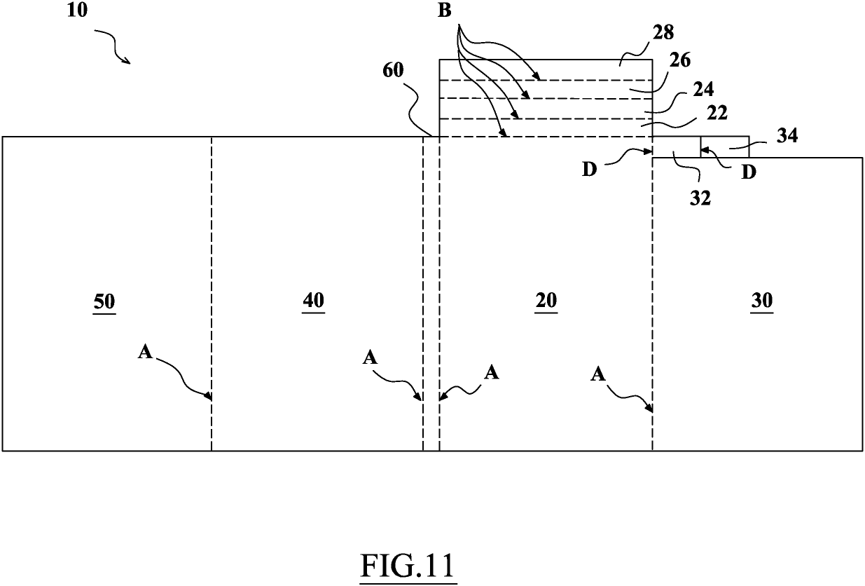

The agenda of the invention can be implemented by folding a sheet, sometimes also referred to as a plate or blank, provided with lines of pre-set folding or creases, and globally denoted by the reference numeral 10 in FIG. 1 (in addition to FIGS. 4 and 11).

The sheet 10 of FIG. 1 has a plurality of elements of square or rectangular or trapezoidal, and in general quadrangular, shape 20,23,40,60,42, joined together, or rather geometrically separated, by corresponding first parallel lines of pre-set folding, or first creases A. These elements 20,23,40,60,42, once folded along such first creases A, form at least part of the agenda cover.

In the present description, the term creases means dry traces implemented on the sheets of paper material, e.g. card stock or cardboard, which make folding easier.

In the implementation of the die-cut sheet 10 of FIGS. 1, 4 and 11, a first element 20 and a second element 40 are placed adjacent to each other and separated by an element 60 through two parallel creases belonging to the aforesaid first creases A. The dimension, in the direction transverse to the creases A, of the element 60 determines the thickness of the agenda.

The first element 20 and the second element 40 define at least part of the opposite sides of the agenda cover.

It should be noted that the elements 20,40,60 are herein referred to as essentially quadrangular. However, any other shape whether or not regular, which allows the method described here to be implemented, may likewise be used.

At the free ends of the first and second elements 20,40 of the sheet 10 of FIG. 1, there are end elements 23,42, also parallel to each other and parallel to the elements 20,40,60, which are of quadrangular and preferably trapezoidal shape, and which are respectively joined to the elements 20,40 through creases belonging to the aforesaid first creases A.

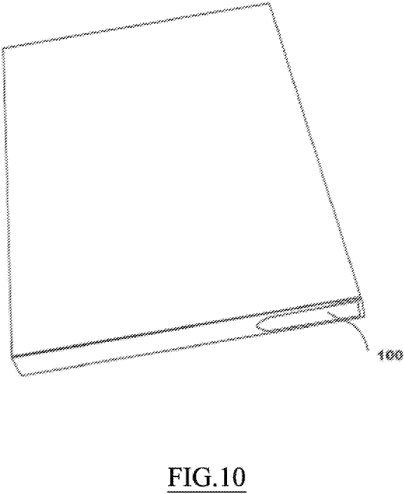

In the sheets 10 of FIGS. 4 and 10, these end elements, which are denoted as 23,50 and 30,50, respectively, have shapes and dimensions different from those 23,42 of the sheet 10 of FIG. 1.

In this regard, it is in any case important to note that the first creases A between the aforesaid elements 20,23 (or 30), 40,42 (or 50),60 are parallel to each other, even if these elements 20,23 (or 30), 40,42 (or 50),60 may also assume a non-quadrangular shape (e.g. with two opposite curvilinear sides not affected by the aforesaid creases).

The elements 20,23 (or 30), 40, 42 (or 50) and 60 of the die-cut sheet 10 are preferably five in number, but as will be clear to those skilled in the art, for the making of an agenda cover it is sufficient that their number be at least three.

It is not excluded that a die-cut sheet, according to the present invention, comprises any number of the aforesaid elements, even if higher than three, and preferably substantially parallel to each other and quadrangular, in any case joined, or rather internally separated, by parallel creases A, for defining the agenda cover.

According to a preferred aspect, the die-cut sheet 10 of FIG. 1, as well as that of FIG. 4 (but not that of FIG. 11), provides that some of the elements 20,40 are equipped with perimeter flaps 21,41,43 preferably quadrangular and more preferably trapezoidal, which are joined, or rather geometrically separated, from the respective element 20,40 by third creases C which are transverse to the aforesaid first creases A.

More particularly, FIG. 1 shows that, on one side of the element 20 and on two sides of the element 40, there are these trapezoidal-shaped perimeter flaps 21,41,42. These perimeter flaps, which are foldable along the respective creases C that are transverse to the first creases A, once folded on the elements 20 and 40 have the function of reinforcing the edges of the cover and making them aesthetically more pleasing by hiding the section of the card stock.

The same function is achieved by folding the end elements 23,42, which are also trapezoidal, onto the respective elements 20,40, through the creasing lines which join them (or separate them geometrically) from the respective element 20,40.

Again FIG. 1, but this solution is also found in FIG. 4 and FIG. 11, shows that on the upper side of the first element 20, preferably quadrangular strips 22,24,26,28 are connected, which are also implemented by creasing.

These second creases B are transverse, preferably orthogonal, to the first creases A which join, or rather separate internally, the elements 20,40,60 and are preferably parallel to each other.

As will become clearer hereinafter, the quadrangular strips 22,24,26,28 are intended to be folded to form a tubular case which constitutes the housing for a writing instrument integrated in the agenda. Since this tubular frame (or case) can preferably have a square, rectangular or in any case polygonal section, with at least one open base, the number of quadrangular strips 22,24,26,28 provided is at least equal to four. It is not excluded that this number may be higher.

In the case of four preferably quadrangular strips, 22,24,26,28 of the die-cut sheet 10 depicted in FIG. 1, or in FIG. 4 or in FIG. 11, it is noticeable that their folding along the second creases B is carried out so that they define the three sides 22,24,26 of a prism-shaped tubular frame with square/rectangular base and a side 28 for fastening to the element 20 to which the strips 22,24,26,28 are joined.

Optionally, as can be seen in FIG. 1 (but also in FIGS. 4 and 11), the die-cut sheet 10 can provide for additional fins 32 and 34, preferably quadrangular and two in number, which in FIG. 1 are connected to the first element 20 and are foldable along respective fourth creases D, preferably shown as parallel to the first creases A.

As will be seen, the folding of these additional fins 32,34 allows to close an open end of the tubular frame made by folding the quadrangular strips 22,24,26,28. Above all, but not necessarily, if the aforesaid additional fins 32,34 are not present, it is possible to provide for a stabilising body to be inserted inside the tubular frame (case) defined by the quadrangular strips 22,24,26,28, which body can be constituted by a specially die-cut and folded card stock sheet of such dimensions and shape as to be inserted in contact with the inner walls of such tubular frame (case) and to increase the compressive or tensile strength of the same tubular frame.

The stabilizing body can be constituted by any other object adapted to constitute as a stabiliser, comprising the same writing instrument intended to be housed.

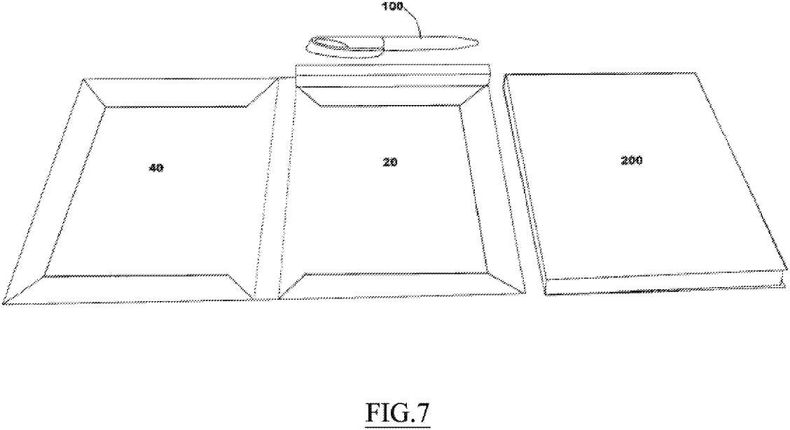

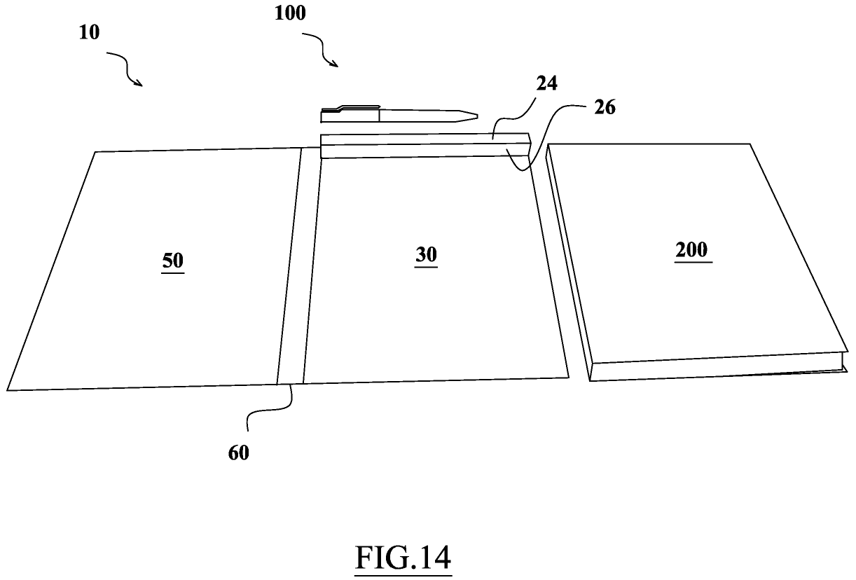

As will be apparent later (e.g. see FIGS. 7, 8 and 9 or FIG. 14), the agenda herein disclosed is completed by fastening at least one block 200 of paper sheets to the sheet 10, so that the tubular frame 22, 24, 26, 28 is completely arranged above the block 200 of paper sheets. In this way, the tubular frame 22, 24, 26, 28 does not hinder the flipping through of the paper sheets of the block 200 or the writing thereon.

In other words, the tubular frame 22, 24, 26, 28 never overlaps the block 200 of paper sheets, so that the user of the agenda has no hindrances when he/she intends to leaf through the paper sheets of the block 200 and/or to write on them.

As will be discussed later, the tubular frame 22, 24, 26, 28 may also be arranged preferably transversely to the direction of binding of the pages of the block 200 of paper sheets, to allow the user to flip through the sheets of the block 200 of paper sheets and to be able to write in them without being prevented by the encumbrance of the tubular frame 22, 24, 26, 28.

In the light of what has been described above, it will become clear that, in the exemplary embodiment of the invention shown here in FIGS. 1 or 4 or 11, the die-cut paper material sheet 10, which is intended to define the agenda cover with an integrated housing for a writing instrument, comprises at least one plurality of preferably quadrangular and parallel elements 20,40,60 mutually divided in their inside (or rather joined) by a first plurality of parallel creases A, and at least one plurality of quadrangular strips 22,24,26,28 mutually divided in their inside by a second plurality of creases B transverse to the first plurality of parallel creases. The aforesaid plurality of quadrangular strips 22,24,26,28 is connected, through a crease, to a first element 20 of the plurality of parallel quadrangular elements 20,40,60.

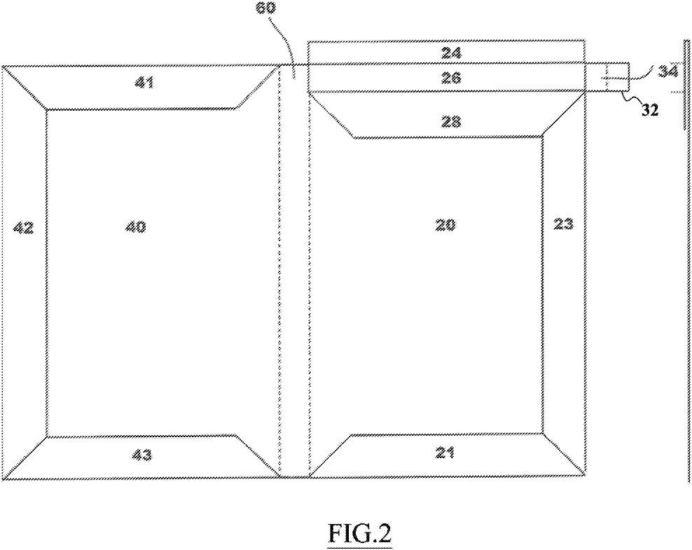

It should be noted that the quadrangular elements 20,40,60 are at least three and the aforesaid quadrangular strips 22,24,26,28 are at least four. FIG. 2 shows the sheet 10 of FIG. 1, in a first step of the method for making the agenda according to an aspect of the invention.

In this first step of the method for making an agenda depicted in FIG. 2, the quadrangular strips 22,24,26,28 are folded around their second creases B in such a way as to form the aforesaid preferably prismatic tubular frame with the strip 28 which, in the embodiment shown here, is that of the free end of these strips 22,24,26,28, which is adhered to the surface of the first element 20 in order to fasten such tubular frame in the pre-set position.

The adhesion of the end strip 28 to the surface of the first element 20, after the folding of these strips 22,24,26,28 has defined a tubular frame, is preferably carried out by gluing.

The strips 22,24,26,28 are preferably rectangular and have a sufficient length to define a tubular frame sufficiently capable of accommodating, at least partially, at least one writing instrument, such as a pen, a pencil, a ruler, etc.

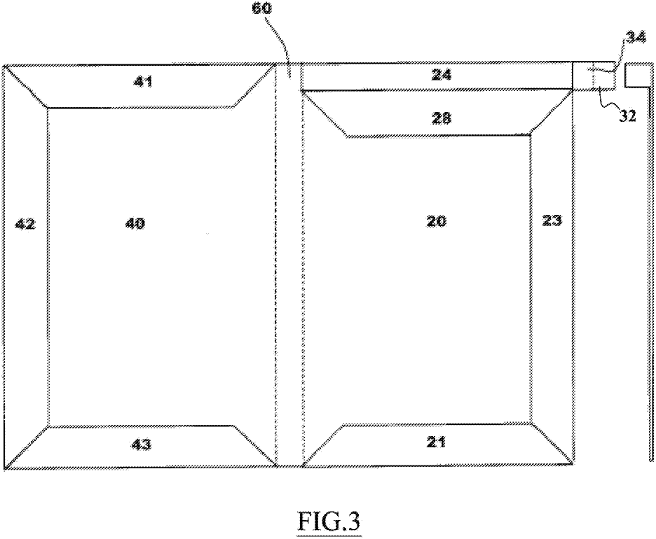

Preferably, the aforesaid tubular frame formed by folding the quadrangular strips 22,24,26,28, and also depicted in FIG. 3, has a substantially square section, even if it can have any other polygonal section.

The elements 20 and 40 which, as mentioned, form the rear and front sides of the agenda cover, preferably have a rectangular shape, even if not necessarily all the elements 20 and 40 have the same dimensions and, in the implementation of the invention described herein, the tubular frame is implemented at the short side of the first element 20.

As already mentioned, if the additional fins 32, 34 are present, their folding allows to close one of the ends of the aforesaid tubular frame otherwise equipped with both open ends, as also depicted in FIG. 3.

FIGS. 2 and 3 also show the steps of folding the trapezoidal end elements 23,42 and the perimeter flaps 21,41,43 on the first element 20 and on the second element 40, respectively, so as to define the opposite sides of the agenda cover.

The trapezoidal outline of these elements 23,42 and of these perimeter flaps 21,41,43 allows them, once folded and fastened — preferably by gluing — to the respective first or second element 20,40, to be juxtaposed with each other without interference and to strengthen such sides of the agenda cover.

It is noticeable that the folding of the end element 23 of the first element 20 and its respective fastening, preferably by gluing, to the latter does not interfere, i.e. is not superimposed, with the strip 28 which is folded and fastened to the first element 20 but is juxtaposed to such strip 28.

In alternative embodiments, the end element 23 may be shaped to be at least partially superimposed on the aforesaid strip 28 which is folded and fastened to the first element 20.

FIG. 4 depicts a variation of the agenda of the invention.

The sheet 10 of FIG. 4 also has a plurality of square or rectangular, and in general quadrangular, elements 20,23,40,50,60 and a plurality of perimeter flaps 21,41,43 which, once folded along lines of pre-set folding, or creases, A, C and fastened preferably by gluing, form the agenda cover.

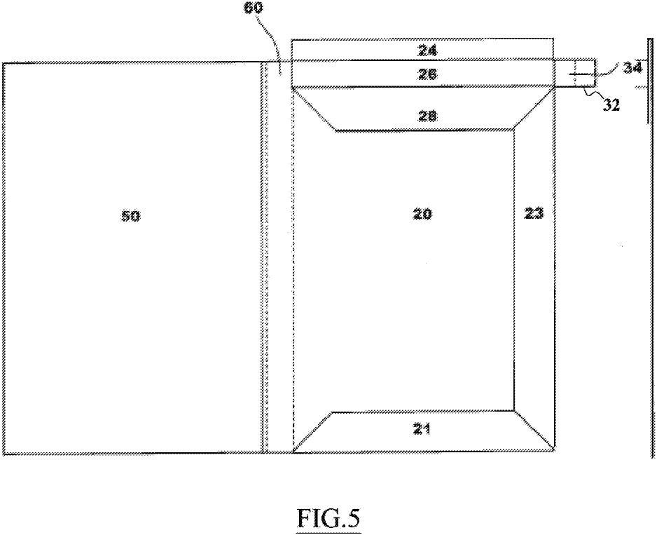

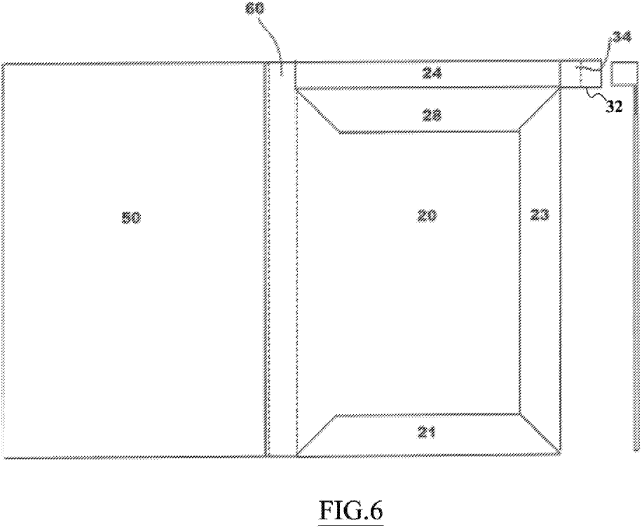

In this variation, however, next to the element 40 (on the left side in the figure), an element 50 has been arranged with dimensions and shape similar to those of the second element 40 to which it is joined, instead of the trapezoidal element 42 of FIG. 1. This way it is possible to implement, with the same method provided for the cover of FIG. 1 and shown in FIGS. 5 and 6, another type of cover which has the element 50 free to be folded above the element 40.

In other words, the positioning of the element 50 above the element 40 occurs in such a way that the element 50 covers the perimeter flaps 41 and 43 that adhere to the second element 40 and, at the same time, a side of the agenda cover is formed, as shown in FIG. 5.

Similar to the case of the sheet 10 of FIG. 1, the quadrangular strips 22,24,26,28 are folded around their second creases B in such a way as to form a tubular frame, as shown in FIG. 6, with one of the strips 28 fastened to the first element 20.

The trapezoidal end element 23 is then folded and fastened on the first element 20 to form a side of the cover.

Also in this case, the die-cut sheet 10 has two additional fins 32,34 connected, through crease D, to the first element 20 and divided from each other by a crease transverse, preferably orthogonal, to the second creases B which divide the quadrangular strips 22,24,26 and 28.

The additional fins 32,34, which may generally be one or more, are preferably connected to said first element 20 but can also be connected, through a crease, to one of said quadrangular strips 22,24,26,28, in particular to the strip 22 which joins the quadrangular strips 22,24,26,28 to the first element 20.

The dimensions of these additional fins 32,34 are such as to allow, once folded, the occlusion of an open end of the tubular frame (case) defined by the quadrangular strips 22,24,26,28, with e.g. the end fin 34 inserted into the tubular frame, possibly glued.

The die-cut sheet 10 depicted in FIG. 11 provides, unlike the sheet 10 of FIG. 1, that the end elements 30, 50, i.e. the elements placed on the free sides of the first and second elements 20, 40, are substantially rectangular in shape and have dimensions such as to be able to be superimposed, once folded around the creasing lines A, on the respective elements 20,40.

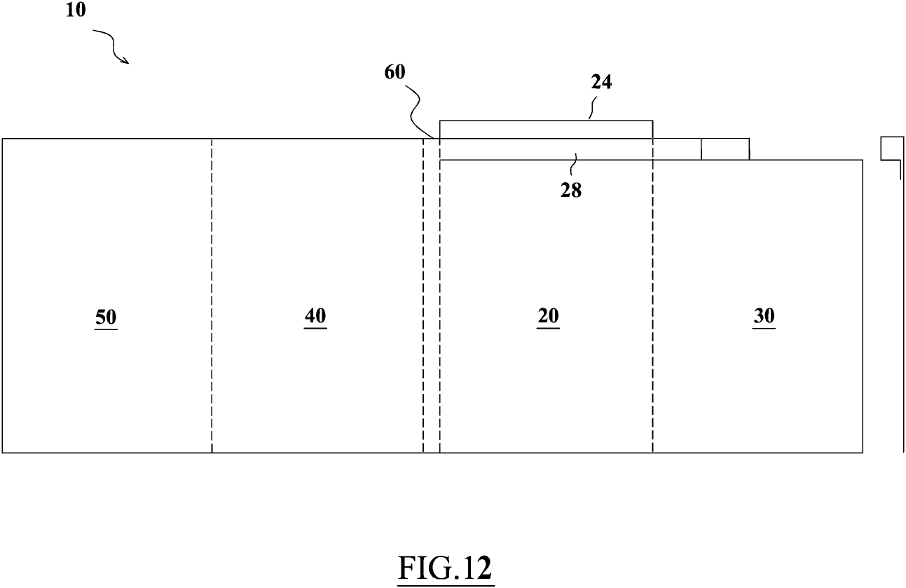

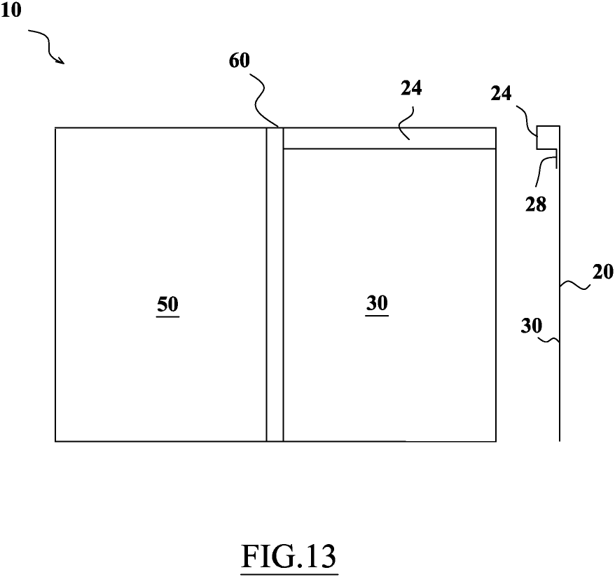

The method for the making of an agenda which makes use of the sheet 10 of FIG. 11, schematically shown in FIGS. 12 and 13, is entirely similar to that described with reference to the embodiments of FIGS. 1 and 4.

Unlike the preceding embodiments, however, the method that uses the sheet 10 of FIG. 11 provides that, after the step of folding the plurality of quadrangular strips 22,24,26,28 around the respective creases B in such a way as to form a tubular frame in which one of such strips 28 is adhered to the surface of the first element 20, the subsequent step of folding the elements 30,50 occurs in such a way that the end element 30 joined to the first element 20 is superimposed, and is preferably fastened by gluing, above the first element 20 and also above the strip 28 which has been adhered to the same first element 20.

FIG. 7 is an axonometric view of the agenda of the invention, in a making step in which a block 200 of paper sheets is added thereto.

The block 200 of paper sheets is, for example, glued on the first element 20, below the tubular frame defined by the strips 22,24,26,28.

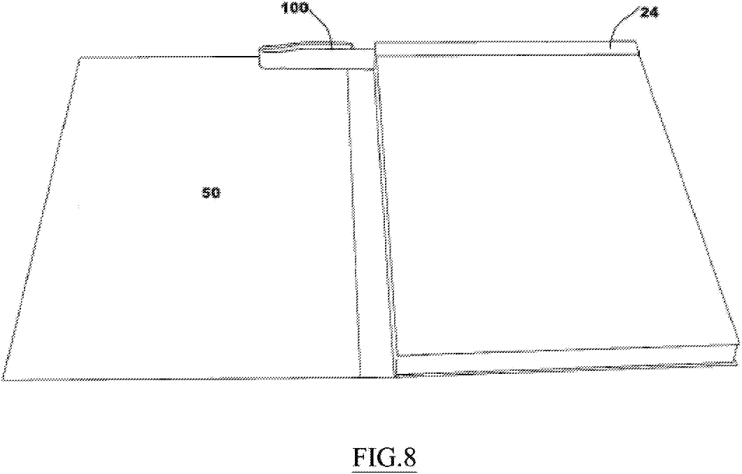

In an alternative embodiment (FIG. 8), the block 200 of paper sheets is book-like bound, i.e. a long side of the rectangular sheets is joined to form a binding, e.g. by gluing or sewing, and the first and last pages of the book are glued to the elements 20 and 40 by the technique of the flyleaves.

Other methods of fastening the block 200 of paper sheets to the sheet 10 constituting the agenda cover may be provided, as long as the block 200 of paper sheets, when the agenda is complete, extends below the tubular frame intended to house a writing instrument.

FIG. 7 also depicts, by way of example, a pen 100 which can be used in combination with the agenda.

FIG. 8 depicts the agenda of the invention with the block 200 of paper sheets applied thereto and the pen 100 partially inserted inside the tubular frame formed by folding the quadrangular strips 22,24,26,28.

Optionally, the rectangular fins 32 and 34 may be folded to close the side of the tubular frame opposite the side for inserting the pen 100.

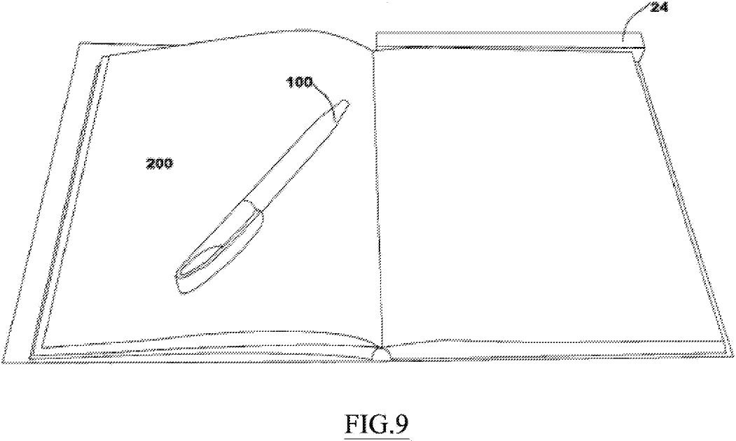

FIG. 9 is a further axonometric view of the agenda of the invention of FIG. 1 in open configuration.

Finally, FIG. 10 is an axonometric view of the agenda of the invention in closed configuration shown from the side of the housing for the writing instrument.

As mentioned, the agenda thus implemented provides that the tubular frame defined by the quadrangular strips 22,24,26,28 and constituting the housing for at least one writing instrument, is arranged above the block 200 and transversely to the direction of binding of the pages of the block 200 of paper sheets, to allow the user to flip through the agenda and to be able to write in it without being prevented by the encumbrance of the same tubular frame.

Modifications or improvements that are dictated by contingent or particular reasons, without thereby departing from the scope of the invention, may be made to the invention as described herein.

1. A Method for making an agenda with an integrated housing for a writing instrument, the agenda being achievable by folding a sheet provided with lines of preset folding or creases, where the sheet has a plurality of elements adapted to form at least partially the cover of the agenda and mutually separated in their inside by corresponding first parallel creases, and a plurality of optionally quadrangular strips mutually separated in their inside by corresponding second creases which are arranged transversely to said first parallel creases, said plurality of strips being connected to a first element of the plurality of elements, the method comprising:
a) folding the plurality of strips to form a tubular frame in which one of the strips is adhered to the surface of the first element to fasten said tubular frame in position;
b) folding said plurality of elements so that said first element constitutes a part of one side of the agenda cover, a second element constituting at least part of a second side of the agenda cover; and
c) fastening a block of sheets to the sheet, so that said block (200) of sheets extends below said tubular frame.

2. The method of claim 1, further comprising:
d) positioning and fastening a third element above said first element so that the aforesaid third element surmounts or flanks the aforesaid strip which adheres to the first element, to form at least one first side of the agenda cover.

3. The method of claim 1, further comprising:
positioning and fastening a fourth element above the second element to form at least part of a second side of the agenda cover.

4. The method of claim 1, wherein one element of the plurality of elements comprises one or more perimeter flaps separated from the respective element by third creases transverse to said first creases, the method also comprising the step of folding and fastening said perimeter flaps to define said first and said second sides of the agenda cover.

5. The method of claim 1, wherein the fastening involving at least one of said quadrangular strips and/or at least one of said plurality of elements and/or at least one of said perimeter flaps is made by gluing.

6. The method of claim 1, wherein the said sheet comprises one or more additional fins connected to the said first element or to one of said quadrangular strips, and wherein the method comprises a further step of folding said one or more additional fins to close one side of the tubular frame.

7. The method of claim 1, wherein the step of folding the plurality of quadrangular strips to form the tubular frame occurs in such a way as to form a tubular frame with a substantially square section.

8. The method of claim 1, wherein the elements which form at least part of the sides of the agenda cover have rectangular shape and the tubular frame is made at the short side of said first element.

9. The method of claim 1, wherein said tubular frame is arranged above the block of paper sheets and transversely to the direction of binding of the paper sheets of the block.

10. A die-cut paper material sheet for making an agenda with an integrated housing for a writing instrument, comprising a plurality of parallel elements mutually divided in their inside by a first plurality of parallel creases and at least one plurality of quadrangular strips mutually divided in their inside by a second plurality of creases transverse to the first plurality of parallel creases, wherein said plurality of strips is connected, through a crease, to a first element of the plurality of parallel quadrangular elements, said quadrangular elements being at least three and said quadrangular strips being at least four.

11. The die-cut sheet according to claim 10, wherein said sheet comprises one or more flaps separated from at least one respective element of said plurality of elements by third creases transverse to said first creases.

12. An agenda equipped with an integrated housing for a writing instrument, made according to the method of claim 1.
